(19) United States
(12) Patent Application Publication
(10) Pub. No.: US 2009/0100809 A1
(43) Pub. Date: Apr. 23, 2009

(54) FILTER ASSEMBLY FOR REMOVING PARTICULATES IN AN EXHAUST GAS IN A FUEL ENGINE

(76) Inventors: Donald W. Baldwin, JR., Perrysburg, OH (US); Bradley R. Postage, Simpsonville, SC (US)

Correspondence Address: CANTOR COLBURN, LLP, 20 Church Street, 22nd Floor, Hartford, CT, 06103, US

(21) Appl. No.: 12/254,623

(22) Filed: Oct. 20, 2008

Related U.S. Application Data
(60) Provisional application No. 60/982,129, filed on Oct. 23, 2007.

(51) Int. Cl. B01D 50/00; B01D 39/20

(52) U.S. Cl. 55/318

(57) ABSTRACT

A filter assembly for removing particulates in an exhaust gas in a fuel engine is provided. The filter assembly comprises a primary filter having a first side and a second side, the primary filter configured to remove an amount of particulates from the exhaust gas flowing from the first side to second side; and a foam element disposed proximate to the first side of the primary filter, the foam element configured to remove another amount of particulates from the exhaust gas.

### CROSS REFERENCE TO RELATED APPLICATIONS

This application claims the benefit of U.S. Provisional Patent Application Ser. No. 60/982,129 filed Oct. 23, 2007 the contents of which are incorporated herein by reference thereto.

### BACKGROUND

The present invention relates to a foam pre-filter for use in diesel exhaust systems. More particularly, the present invention relates to a foam pre-filter that can be incorporated into diesel exhaust treatment devices for enabling higher soot capacity in the same or less space.

Diesel particulate filters (DPFs) are devices installed in diesel engine vehicles or the like that collect particulate matter (PM) without obstructing the flow of exhaust gases or damaging the vehicle. Because regulatory agencies have recently mandated the reduction of particulate emissions in diesel engines, there has been increased activity in the development of diesel particulate filters, that is, exhaust emission filters for diesel engines. The role of a typical diesel particulate filter is to trap or catch the particulate components of the diesel exhaust stream, which include diesel soot and aerosols such as ash particulates, metallic abrasion particles, sulfates, and silicates, to prevent their discharge from the tailpipe of the vehicle. This particulate matter has been identified as a potential health hazard.

A variety of diesel particulate filtration technologies exist in the market. In each of these technologies, importance is placed on providing a diesel particulate filter that provides long-term operation without diminishing the filtration efficiency of the filter and performance of the engine. Factors related to the performance of diesel particulate filters include but are not limited to high temperatures (e.g., up to 1400° C.), capability to store soot and ash, pressure loss, low thermal mass, stability, and durability.

The filtration is achieved by a porous structure (e.g. filter media) that allows transmission of the fluid phase but stops or captures diesel particulate matter larger than a threshold particle size. Variations in the filter's efficiency are a function of the pore size of the filter media and particle size of the diesel particulate matter thus, every filter has a finite capacity, and as the flow through a diesel particulate filter decreases exhaust backpressure increases, which is undesirable. Most filtration mechanisms are incorporated within a canister or can and placed proximate to the vehicle engine, which in most instances have limited compartment space. Consequently, filtration mechanisms need to be designed to fit the limited space provided in various vehicles, which usually will limit the size of filter media, thus limiting the soot capturing capacity or filtration capacity of the filtration mechanisms. In other words, the amount or volume of soot captured usually depends on the size or volume space of the filter media in the filtration mechanism, which in having a small size of filter media in the filtration mechanism due to the limited amount of space provided in a particular vehicle will result in capturing a small amount or volume of soot from the exhaust stream.

Accordingly, it is desirable to provide a foam pre-filter that can be incorporated into diesel exhaust treatment devices for enabling higher soot capacity in the same or less space. Other desirable aspects will become apparent in the description below.

### SUMMARY OF THE INVENTION

In one exemplary embodiment, a filter assembly for removing particulates in an exhaust gas in a fuel engine is provided. The filter assembly comprises a primary filter having a first side and a second side, the primary filter configured to remove an amount of particulates from the exhaust gas flowing from the first side to second side; and a foam element disposed proximate to the first side of the primary filter, the foam element configured to remove another amount of particulates from the exhaust gas.

In another exemplary embodiment, an exhaust treatment device for removing particulates in an exhaust gas in a fuel engine is provided. The exhaust treatment device comprises a housing having an inlet end and an outlet end, the exhaust gas being configured to flow through the inlet end and out the outlet end; a primary filter having a first side and a second side, the first side being proximate to the inlet end and the second side being proximate to the outlet end, the primary filter configured to remove an amount of particulates from the exhaust gas flowing from the first side to second side; and a foam element disposed proximate to the first side of the primary filter, the foam element configured to remove another amount of particulates from the exhaust gas.

In another exemplary embodiment, a diesel particulate filter assembly for removing particulates in an exhaust gas in a fuel engine is provided. The assembly comprises a primary diesel particulate filter having a first side and a second side, the primary diesel particulate filter configured to remove an amount of particulates from the exhaust gas flowing from the first side to the second side, the primary diesel particulate filter is made up of a high temperature ceramic material; and a diesel particulate filter foam element disposed proximate to the first side of the primary diesel particulate filter, the diesel particulate filter foam element configured to remove another amount of particulates from the exhaust gas, the diesel particulate filter foam element is made up of a ceramic foam material, a metal foam material, or a combination of both.

In yet another exemplary embodiment, a method for increasing the filtration capacity in an exhaust treatment device that is configured for removing particulates in an exhaust gas in a fuel engine is provided. The method comprises disposing a primary filter having a first side and a second side within a housing having an inlet end and an outlet end, the primary filter configured to remove an amount of particulates from the exhaust gas flowing from the inlet end to the outlet end; and disposing a foam element proximate to the first side of the primary filter, the foam element configured to remove another amount of particulates from the exhaust gas.

### BRIEF DESCRIPTION OF THE DRAWINGS

FIG. 1 illustrates a cross-sectional perspective view of a foam pre-filter incorporated upstream of a primary filter in accordance with an exemplary embodiment of the present invention;

FIG. 2 illustrates a cross-sectional view of an alternative foam pre-filter incorporated upstream of an alternative primary filter in accordance with an exemplary embodiment of the present invention; and

FIG. 3 illustrates a cross-sectional view of an exemplary embodiment of an exhaust treatment device incorporating the foam pre-filter in FIG. 1 or 2 and the primary filter in FIG. 1 or 2 in accordance with an exemplary embodiment of the present invention.

### DETAILED DESCRIPTION OF EXEMPLARY EMBODIMENTS

Exemplary embodiments of foam pre-filters and particulate filters incorporating the same in accordance with the present invention will now be described with reference to the drawings. The exemplary foam pre-filters described herein are configured to be incorporated upstream of primary filtration mechanisms or primary filter assemblies that are in fluid communication with the exhaust gas pipes of a diesel engine. The exemplary foam pre-filters described herein can be incorporated with conventional wall-flow filter assemblies or other known filter assemblies having filters (e.g. panel filters and round filters) with varying dimensions and applications, all of which are within the scope of this invention. However, for simplistic purposes, only panel filters and round filters that form filter assemblies are discussed in detail below. The exemplary foam pre-filters described herein can also be incorporated with known exhaust treatment devices of varying types that incorporate the varying filter assemblies (e.g. wall-flow filter assembly). The exemplary foam pre-filters described herein will enable for higher soot capacity in exhaust treatment devices in the same existing space or less space within the exhaust treatment device in accordance with one exemplary embodiment of the present invention. Thus, when a foam pre-filter is incorporated in the upstream of a primary filtration mechanism in an exhaust treatment device, exhaust emissions that are discharged from a diesel engine to flow through the exhaust pipe are directed across the foam pre-filter and then across the filter media of the primary filtration mechanism. As such, the foam pre-filter captures an amount of particulate matter from the exhaust gas, while the primary filtration mechanism captures another amount of particulate matter from the exhaust gas. Optionally, the trapped particulate material in either the foam pre-filter and/or primary filtration mechanism can be burned or eliminated by a continuous or periodic oxidation process of any known type. Alternatively, the foam pre-filter may be replaced in the exhaust treatment device or the primary filtration mechanism with a clean foam pre-filter.

For simplistic purposes, exemplary embodiments of a foam pre-filter for removing particulates in an exhaust gas in a diesel engine in accordance with the present invention will be described in greater detail below. However, it should be understood that other types of fuel burning engines can be used in conjunction with the foam pre-filter and should not be limited to diesel engines.

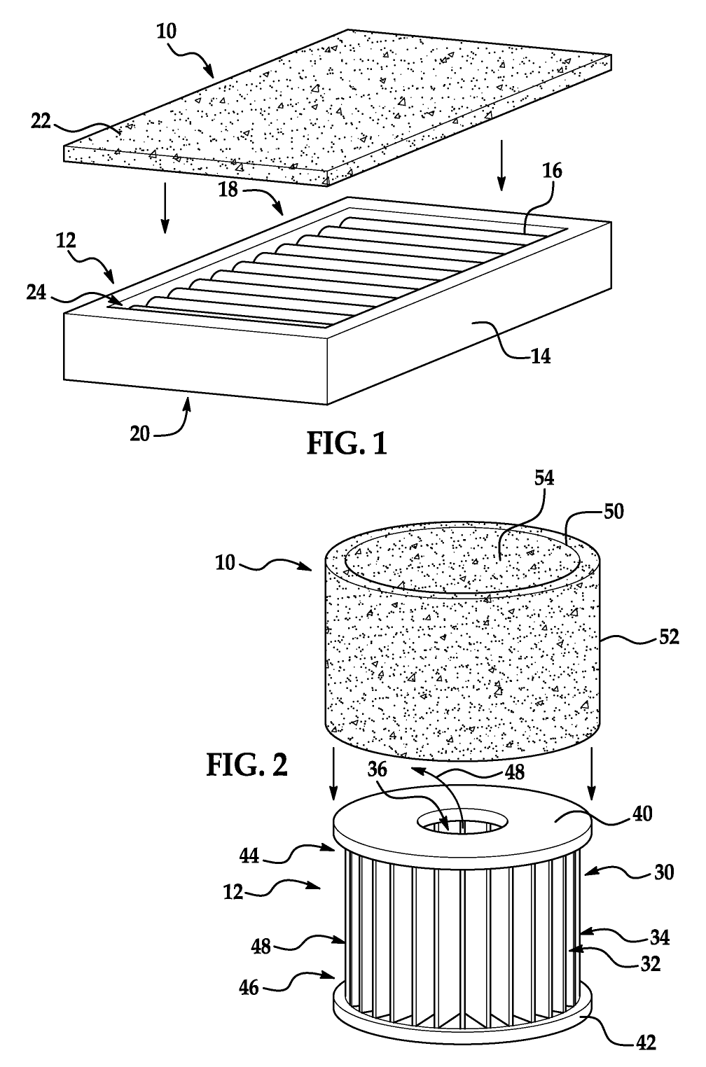

For a better understanding of the invention and its operation, turning now to the drawings, FIGS. 1 and 2 illustrate a foam pre-filter 10 in accordance with exemplary embodiments of the present invention. More specifically, FIGS. 1 and 2 illustrate foam pre-filter 10 being incorporated upstream or in an upstream path of a primary filter 12 for increasing the soot capturing capacity or filtration capacity of an exhaust treatment device to which the primary filter 12 is incorporated into in accordance with exemplary embodiments of the present invention.

In accordance with one non-limiting exemplary embodiment, primary filter 12 is a panel filter that may be one of a plurality of stackable panel filters in a filter assembly that may be incorporated into an exhaust treatment device as shown in FIG. 1. The primary filter 12 includes a frame 14 surrounding a filter element 16, which is configured to remove particulate matter from an exhaust gas, in accordance with one exemplary embodiment of the present invention. The filter element 16 of primary filter 12 has an open pore structure with pore sizes ranging from approximately 10-150 microns in accordance with one non-limiting exemplary embodiment. Of course, other pore sizes are contemplated and should not be limited to the example set forth above. The primary filter 12 includes an inlet flow side 18 and an outlet flow side 20 in which the exhaust gas flows from the inlet flow side 18 to the outlet flow side 20 when the primary filter 12 is incorporated into an exhaust treatment device. The filter element 16 is disposed within and supported by the frame 14, which in accordance with one non-limiting exemplary embodiment constitutes ceramic fibers and can be formed from a ceramic injection molding or casting process. In one non-limiting embodiment, the filter element 16 disposed within the frame 14 has a pleated configuration. Of course, other configurations are contemplated in exemplary embodiments of the present invention and should not be limited to the configuration shown in FIG. 1.

The frame 14 may have a rectangular shape. It is also contemplated the frame have a shape other than rectangular such as, for example, circular, square, oval, or another appropriate shape depending on the application. The size of the frame can be varied depending on the required back pressure, filtration, size, manufacturing, and other requirements of a particular application.

In one non-limiting exemplary embodiment, the filter element 16 is formed from a ceramic fiber material, which in accordance with one non-limiting exemplary embodiment of the present invention is selected from the group consisting of silicon carbide, silicon nitride, cordierite, aluminum oxides, alumina silicate, and combinations thereof. Of course, other materials can be used to form filter element 16, such as a metal fiber material (e.g. stainless). In accordance with one non-limiting exemplary embodiment of the present invention, the ceramic media can be formed by a ceramic injection molding or casting process.

In accordance with one exemplary embodiment, foam pre-filter 10 is disposed proximate the inlet flow side 16 of the primary filter 12 or upstream of the primary filter 12. The foam pre-filter 10 is made up of ceramic foam material, metal foam material, or a combination thereof. In one non-limiting exemplary embodiment, the foam pre-filter 10 has a rectangular cross-sectional shape as shown in FIG. 1. As such, the shape of the foam pre-filter 10 corresponds to the shape of the frame 14 of the primary filter 12 in FIG. 1. It is also contemplated that the foam pre-filter 10 have a cross-sectional shape other than rectangular such as, for example, round, square, oval, or another appropriate shape depending on the application.

In accordance with one non-limiting exemplary embodiment, the foam pre-filter 10 is made up of a metal foam material having open metallic structures made from nickel, aluminum, zinc, titanium, copper or the like. The types of metal foams used to form foam pre-filter 10 can be produced through a variety of known methods, such as the addition of a foaming compound to a molten metal or by bubbling air through molten metal. Of course, other known methods of manufacturing metallic foams are contemplated, such as mixing metal powders with a blowing agent, compacting the mix, and then foaming the compact by melting. In one non-limiting exemplary embodiment, the foam pre-filter 10 is made up of a nickel foam material, which in accordance with one non-limiting exemplary embodiment is manufactured from INCOFOAM®. In another non-limiting exemplary embodiment, the foam pre-filter 10 is made up of a ceramic foam material having open ceramic structures made from oxides, nitrides, carbides, borides, silicides or the like. The types of ceramic foams used to form foam pre-filter 10 can be produced through a variety of known processes, such as dipping the polymer foam in a slurry containing an appropriate binder and ceramic phases, followed by pressureless sintering at elevated temperatures. Of course, other known methods of manufacturing ceramic foams are contemplated and should not be limited to the example described above. In one exemplary embodiment, the foam pre-filter 10 is insert molded with the primary filter 12 using known molding techniques, such as cast molding. The foam pre-filter 10 is an open pore structure (metallic foam or ceramic foam) with pore sizes ranging from approximately 20 microns to 1500 microns in accordance with one non-limiting exemplary embodiment. Of course, other pore sizes are contemplated and should not be limited to the example set forth above. As such, the foam pre-filter 10 may capture larger sized particulate matter while the primary filter 12 may capture smaller sized particulate matter.

In one non-limiting exemplary embodiment, the foam pre-filter 10 is disposed within and supported by the frame 12 of the primary filter 12 near the inlet flow side 16 of primary filter 12. The foam pre-filter 20 can be secured to the frame 14 by any means for securing such as, for example, a ceramic paste, a weld, a braze, a gasket, or any other known means. In one exemplary embodiment, the foam pre-filter 10 is disposed within the frame 14 of the primary filter 12 such that a top surface 22 of the foam pre-filter 10 is aligned with an upper edge surface 24 of the frame 14, thereby requiring no additional space to incorporate foam pre-filter 10 to an exhaust treatment device in which the primary filter 12 is incorporated into while increasing the filtration capacity of the exhaust treatment device. In another exemplary embodiment, the foam pre-filter 10 is disposed within the frame 14 of the primary filter 12 such that a distance is formed between the foam pre-filter 10 and the filter element 16. In an alternative exemplary embodiment, the foam pre-filter is disposed within the frame 14 of the primary filter 12 such that the foam pre-filter 10 engages with portions of the filter element 16. Yet in another alternative exemplary embodiment, the foam pre-filter 10 is disposed atop the frame 14 of the primary filter 12 such that a peripheral edge of the top surface 22 of the foam pre-filter 10 engages with the upper edge surface 24 of the frame 14.

In another non-limiting exemplary embodiment, the foam pre-filter 10 is disposed a distance apart from the primary filter 12 when both are incorporated in an exhaust treatment device, such that the foam pre-filter 10 is incorporated upstream of the primary filter 12 in the exhaust treatment device. More specifically, the foam pre-filter 10 is disposed a distance apart from the inlet flow side 16 of the primary filter 12 when both are incorporated in an exhaust treatment device.

Placing the foam pre-filter 10 upstream of the primary filter 12 in the exhaust treatment device will allow the exhaust gas from the exhaust gas pipe to flow through the foam pre-filter 10 and then through the filter media 16 of the primary filter 12 in FIG. 1. The foam pre-filter 10 will enable for higher soot capacity in the exhaust treatment device in the same existing space (e.g. within the frame of the primary filter). In this arrangement, the foam pre-filter 10 will capture an amount of particulate matter in the exhaust gas as it flows through the foam body, while the primary filter 12 will capture another amount of particulate matter in the exhaust gas as it flows through the filter media 16 of the primary filter, thus increasing the filtration capacity of the exhaust treatment device.

In an alternative exemplary embodiment, the primary filter 12 is a round filter that may be incorporated into an exhaust treatment device as shown in FIG. 2. The primary filter 12 in FIG. 2 includes a cylindrical pleated filter element 30 configured to remove particulate matter from an exhaust gas, in accordance with one exemplary embodiment of the present invention. In one non-limiting exemplary embodiment, the cylindrical pleated filter element 30 comprises a ceramic fiber-based media formed into a plurality of pleats. The plurality of pleats is bent into a cylindrical arrangement so as to form alternately opposing inwardly radiating pleated contours 32 forming an inner periphery and outwardly radiating pleated contours 34 forming an outer periphery. The primary filter 12 in FIG. 2 can be formed from a ceramic injection molding or casting process. The primary filter 12 in FIG. 2 includes a cylindrical core 36 that may be axially positioned within the inner periphery of the cylindrical filter element 30 to form a hollow axial region. The cylindrical core 36 may be of any conventional design and may be made of any material having sufficient strength and which is compatible with the exhaust emissions being filtered. The cylindrical core 36 supports the inner periphery of the cylindrical filter element 30 against forces in the radial direction and also helps to give the filter element axial strength and rigidity against bending. A plurality of core openings (not shown) is formed through the cylindrical core 36 to permit the passage of exhaust emissions into and through the hollow axial region.

The primary filter 12 in FIG. 2 includes a first end disk 40 and a second end disk 42 that are each formed by a ceramic material, which in accordance with one non-limiting exemplary embodiment constitutes ceramic fibers and can be formed from a ceramic injection molding or casting process. The first end disk 40 and the second end disk 42 are secured to a first axial end 44 and a second axial end 46 of the filter element respectively as shown. Conventional techniques, such as by use of an epoxy or thermal bonding, can be used to attach the end disks 40, 42 to axial ends 44, 46 respectively. The first end disk 40 and the second end disk 42 secure the cylindrical filter element 30 therebetween and secure the same into an exhaust treatment device such that an exhaust gas path is formed, which is indicated by arrow 48 in FIG. 2.

In one non-limiting exemplary embodiment, the foam pre-filter 10 has a cylindrical cross-sectional shape as shown in FIG. 2. As such, the shape of the foam pre-filter 10 corresponds to the shape of the primary filter 12 in FIG. 2. The foam pre-filter 10 in FIG. 2 includes an inner cylindrical wall 50 and an outer cylindrical wall 52. The inner cylindrical wall 50 defines a hollow opening 54, which in one exemplary embodiment is configured to receive the primary filter 12 in FIG. 2. In one non-limiting exemplary embodiment, portions of the inner cylindrical wall 50 are secured to portions of the end disks 40, 42 by any means for securing such as, for example, a ceramic paste, a weld, a braze, a gasket, or any other known means. In another non-limiting exemplary embodiment, portions of the inner cylindrical wall 50 are secured to the outwardly radiating pleated contours 34 of cylindrical filter element 30 by any means for securing such as, for example, a ceramic paste, a weld, a braze, a gasket, or any other known means. The foam pre-filter 10 in FIG. 2 is incorporated upstream of the primary filter 12 in FIG. 2 such that the exhaust gas from the exhaust gas pipe flows through the foam pre-filter 10 and then through the cylindrical filter element 30 of the primary filter 12 in FIG. 2 when both are incorporated within an exhaust treatment device. The foam pre-filter 10 in FIG. 2 will capture an amount of particulate matter in the exhaust gas as it flows through the foam body, while the primary filter 12 will capture another amount of particulate matter in the exhaust gas as it flows through the cylindrical filter element 30 of the primary filter 12 in FIG. 2.

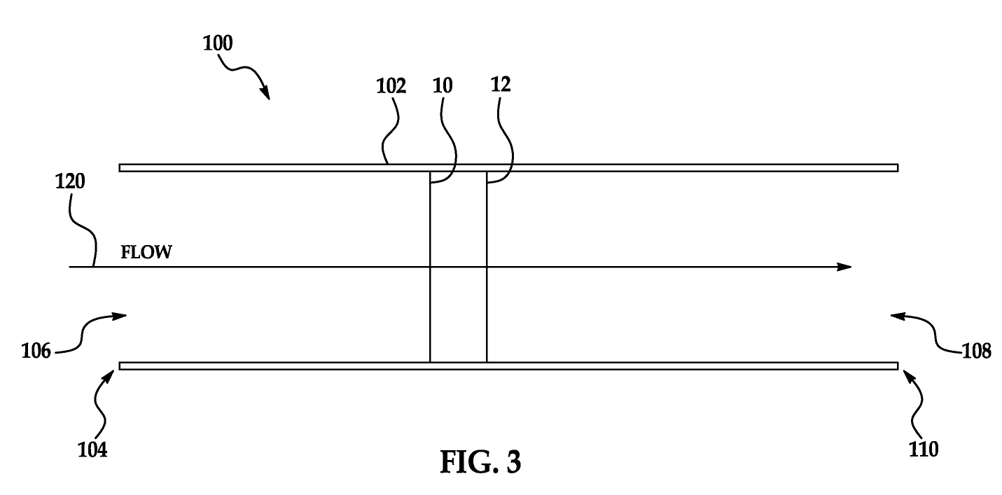

In accordance with the present invention, FIG. 3 illustrates an exemplary embodiment of an exhaust treatment device 100 that correspondingly incorporates the exemplary primary filter 12 and foam pre-filter 10 of FIG. 1 or 2. Exhaust treatment device 100 may be configured to receive emissions from an exhaust-producing system (not shown) and to remove particulates and gaseous compounds from the emissions before being exhausted to the atmosphere. The exhaust treatment device 40 may include a housing canister or can 102 for disposing the primary filter 12 and the foam pre-filter 10 therein. In one non-limiting exemplary embodiment, housing canister 102 is constructed out of metal, such as stainless steel. Of course, other suitable metals or non-metals can be used to form housing canister 102. The housing canister 102 includes an exhaust inlet 104 for receiving an exhaust flow from the exhaust-producing system, an inlet chamber 106, an outlet chamber 108, and an exhaust outlet 110. The housing canister 102 may have any cross-sectional shape along its length, such as, for example rectangular. The shape of the housing canister 102 may be of any suitable shape for incorporating the primary filter 12 and foam pre-filter 10. In other words, the housing canister 102 can be configured to receive a conical shaped filter, panel shaped filter arrangement, or other known filter arrangements. The exhaust inlet 104 and the exhaust outlet 110 may also have any cross-sectional shape, such as oval, square, rectangular, triangular, or any other suitable cross-section depending on the application.

In one exemplary embodiment, the primary filter 12 of FIG. 1 or 2 is disposed within the housing canister 102 and in fluid communication with an exhaust gas path indicated by arrow 120 in FIG. 3. As described above, the foam pre-filter 10 may be disposed upstream of the primary filter 12, forming a distance between the primary filter 12 and the foam pre-filter 10. Otherwise, the foam pre-filter 10 may be disposed within the structure of the primary filter 12 (e.g. within the frame in FIG. 1), thus requiring no additional space within the exhaust treatment device when incorporating the foam pre-filter 10 upstream of the primary filter 12.

When the foam pre-filter 10 and primary filter 12 of FIG. 1 or 2 are incorporated into the exhaust treatment device 100 as described above, the present exemplary exhaust treatment device operates in the following manner. When the diesel engine is driven, exhaust emissions bearing hazardous particulates are directed into the exhaust gas path 120 in FIG. 3 via the exhaust pipe to flow into the exhaust inlet 104 of housing canister 102. The exhaust emissions are directed into the exhaust inlet 104 of the housing 102 and proceed in a generally linear manner to the exhaust outlet 110 of the housing 102. As the exhaust emissions flows through the exhaust inlet 104 and out the exhaust outlet 110, an amount of particulates in the exhaust emissions are captured by the foam pre-filter 10 and another amount of particulates in the exhaust emissions are captured by the primary filter 12.

The open structure of the foam pre-filter 10 serves to increase the overall particulate matter capacity of the exhaust treatment device. It should be understood that the size of the foam pre-filter 10 and the depth of filtration of the foam pre-filter 10 can be of any size, depth, or configuration depending on the needed capacity, the application, and the foam structure itself. It should also be understood that any number of foam pre-filters could be disposed upstream of any primary filtration mechanism for further increasing the filtration capacity of an exhaust treatment device. The size and configurations of the filters or filter assemblies illustrated in FIGS. 1 and 2 should be considered as non-limiting examples. It is contemplated that alternative exemplary embodiments of primary filter 12 could, for instance, include filter elements, frames, or end disks being configured differently based on the application. In other words, the foam pre-filter 10 can be used in conjunction with a filter or filter assembly of any type, size, or configuration and should not be limited to the exemplary filters or filter assemblies described above. The foam pre-filter 10, such as the one described in FIGS. 1 and 2, can be used with any known filter or filter assembly and be incorporated upstream of the known filter or filter assembly to increase overall particulate matter capacity of the exhaust treatment device in which both are incorporated into. The foam pre-filter 10 may be replaced in the exhaust treatment device 100 or the primary filter 12 with another foam pre-filter when the filtration efficiency of the foam pre-filter 10 has diminished.

In accordance with an exemplary embodiment of the present invention, an exemplary method for increasing the filtration capacity in an exhaust treatment device that is configured for removing particulates in an exhaust gas in a diesel engine is provided. In this exemplary method, primary filter 12 in FIG. 1 or 2 is disposed within housing canister 102. Next, foam pre-filter 10 in FIG. 1 or 2 is disposed upstream of the primary filter 12 within housing canister 102. As such, when the diesel engine is driven, exhaust emissions bearing hazardous particulates are directed into exhaust gas path 120 of housing canister 102. The exhaust gas flows through the foam pre-filter, thus capturing an amount of particulates from the exhaust gas. Then, the exhaust gas flows through the primary filter 12, thus capturing another amount of particulates from the exhaust gas. Of course, in this exemplary method, the foam pre-filter 10 may be disposed within the structure of the primary filter 12 or disposed a distance apart from the primary filter 12 within the housing canister 102 as described above.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best include all embodiments falling within the scope of the present application.

What is claimed is:

1. A filter assembly for removing particulates in an exhaust gas in a fuel engine, the assembly comprising:
a primary filter having a first side and a second side, the primary filter configured to remove an amount of particulates from the exhaust gas flowing from the first side to second side; and
a foam element disposed proximate to the first side of the primary filter, the foam element configured to remove another amount of particulates from the exhaust gas.

2. The filter assembly as in claim 1, wherein the foam element is located upstream of the primary filter, the exhaust gas flows through the foam element before the primary filter.

3. The filter assembly as in claim 1, wherein the foam element is made up of a ceramic foam material, a metal foam material, or a combination of both.

4. The filter assembly as in claim 1, wherein the foam element is made up of a metal foam material having a plurality of open metallic structures formed out of a material comprising of: nickel, aluminum, zinc, titanium, copper, iron, or combinations thereof.

5. The filter assembly as in claim 4, wherein each of the plurality of open metallic structures has a pore size ranging from 20 microns to 1500 microns.

6. The filter assembly as in claim 1, wherein the foam element is made up of a nickel foam material.

7. The filter assembly as in claim 1, wherein the foam element is made up of a ceramic foam material having a plurality of open ceramic structures formed out of a material comprising of: oxides, nitrides, carbides, borides, silicides, or a combination thereof.

8. The filter assembly as in claim 7, wherein each of the plurality of open ceramic structures has a pore size ranging from 20 microns to 1500 microns.

10. The filter assembly as in claim 1, wherein the primary filter comprises a frame defining a perimeter for supporting a filter element, the perimeter surrounding a portion of the filter element.

11. The filter assembly as in claim 1, wherein the primary filter comprises:
a first end disk and a second end disk; and
a filter element secured between the first end disk and the second end.

12. An exhaust treatment device for removing particulates in an exhaust gas in a fuel engine, comprising:
a housing having an inlet end and an outlet end, the exhaust gas being configured to flow through the inlet end and out the outlet end;
a primary filter having a first side and a second side, the first side being proximate to the inlet end and the second side being proximate to the outlet end, the primary filter configured to remove an amount of particulates from the exhaust gas flowing from the first side to second side; and
a foam element disposed proximate to the first side of the primary filter, the foam element configured to remove another amount of particulates from the exhaust gas.

13. The exhaust treatment device as in claim 12, wherein the foam element is located upstream of the primary filter, the exhaust gas flows through the foam element before the primary filter.

14. The exhaust treatment device as in claim 12, wherein the foam element is made up of a metal foam material having a plurality of open metallic structures formed out of a material comprising of: nickel, aluminum, zinc, titanium, copper, iron, or combinations thereof.

15. The exhaust treatment device as in claim 145, wherein each of the plurality of open metallic structures has a pore size ranging from 20 microns to 1500 microns.

16. The exhaust treatment device as in claim 12, wherein the foam element is made up of a nickel foam material.

17. The exhaust treatment device as in claim 12, wherein the foam element is made up of a ceramic foam material having a plurality of open ceramic structures formed out of a material comprising of: oxides, nitrides, carbides, borides, silicides, or a combination thereof.

18. The exhaust treatment device as in claim 12, wherein the primary filter comprises a frame defining a perimeter for supporting a filter element, the perimeter surrounding a portion of the filter element.

19. The exhaust treatment device as in claim 12, wherein the primary filter comprises:
a first end disk and a second end disk; and
a filter element secured between the first end disk and the second end.

20. A diesel particulate filter assembly for removing particulates in an exhaust gas in a fuel engine, the assembly comprising:
a primary diesel particulate filter having a first side and a second side, the primary diesel particulate filter configured to remove an amount of particulates from the exhaust gas flowing from the first side to the second side, the primary diesel particulate filter is made up of a high temperature ceramic material; and
a diesel particulate filter foam element disposed proximate to the first side of the primary diesel particulate filter, the diesel particulate filter foam element configured to remove another amount of particulates from the exhaust gas, the diesel particulate filter foam element is made up of a ceramic foam material, a metal foam material, or a combination of both.
